(19) United States
(12) Patent Application Publication
(10) Pub. No.: US 2014/0103159 A1
(43) Pub. Date: Apr. 17, 2014

(54) Tunnel wing system for lift, altitude flight, and ground effect flight

(71) Applicant: Wayne Curtis Bert, Raleigh, NC (US)

(72) Inventor: Wayne Curtis Bert, Raleigh, NC (US)

(21) Appl. No.: 13/654,371

(22) Filed: Oct. 17, 2012

(51) Int. Cl. B60V 3/08; B64C 9/00; B64C 11/00; B64C 3/00

(52) U.S. Cl. CPC B60V 3/08; B64C 3/00; B64C 9/00; B64C 11/001
USPC 244/36; 244/65; 244/87; 180/117

(57) ABSTRACT

Aircraft comprising a single wing suspended under a closed sided chassis. The wing spar is mounted to the sides that enclose and channel the airflow over and under the wing to provide lift. Airflow is provided by a source located in front of the wing by means of either propeller, ducted fan or similar devise. Engines mounted on a rotational engine mount can provide downward thrust to lift front of craft to obtain an angle great enough for lift-off Once aircraft has sustained-angle for lift off engine(s) rotate to produce airflow parallel to wing for flight. Rudders mounted behind the air source and prior to the wing provide steering.

Related U.S. Patent Documents

| Application Number | Issue Date | Name |
|---|---|---|
| 2,928,238 | March 1960 | Hawkins |
| 3,154,267 | October 1964 | Grant, etal |
| 3,785,593 | July 1974 | Von Ohain, etal |
| 4,568,042 | February 1986 | Carr |
| 4,824,048 | April 1989 | Kim |
| 6,840,478 | January 2005 | Carr |
| 7,104,498 | September 2006 | Englar, etal |
| 7,258,302 | August 2007 | Carr |
| D487776 | February 2004 | Carr |
| D598838 | August 2009 | Carr |

### SUMMARY

Embodiments of the design of this invention are intended to form the basis for a new type aircraft that can be used in private and governmental sectors. The uniqueness of the design is based on the concept of the inventor. The invention creates a new mode of affordable transportation. Both the aircraft and the ground effect craft are based on the same principals. The ground effect craft specifically designed to only operate in the ground effect. The ground effect being described as the area close to the surface over which it is operating that is necessary for flight.

The craft are basically the same in design so only where a technical difference is incorporated will there be separate mention in this summary.

The craft incorporates a body design that houses a wing in the undercarriage. This wing provides the primary lift for the craft. The wing may be rigid high lift style wing or incorporate lift augmenting devises. Low pressure is developed on the top side of the wing and higher ram pressure on the underside of the wing. Air is forced to the wing under pressure from either a ducted fan (s), or propeller(s). After the air source and before the wing is where the rudders are located this is what gives the craft its high maneuverability at low speeds.

A design of length to width of approximately 2:1 or less desirable ratio for a stable craft.

A craft made of floatation type material is also more desirable for weight and travel over water.

The design is the basis for various body designs to be installed on top.

### BRIEF DESCRIPTION OF THE DRAWINGS

FIG. 1; Illustrates a perspective view of an embodiment of an aircraft having a tunnel wing design. The configuration is normal flight configuration.

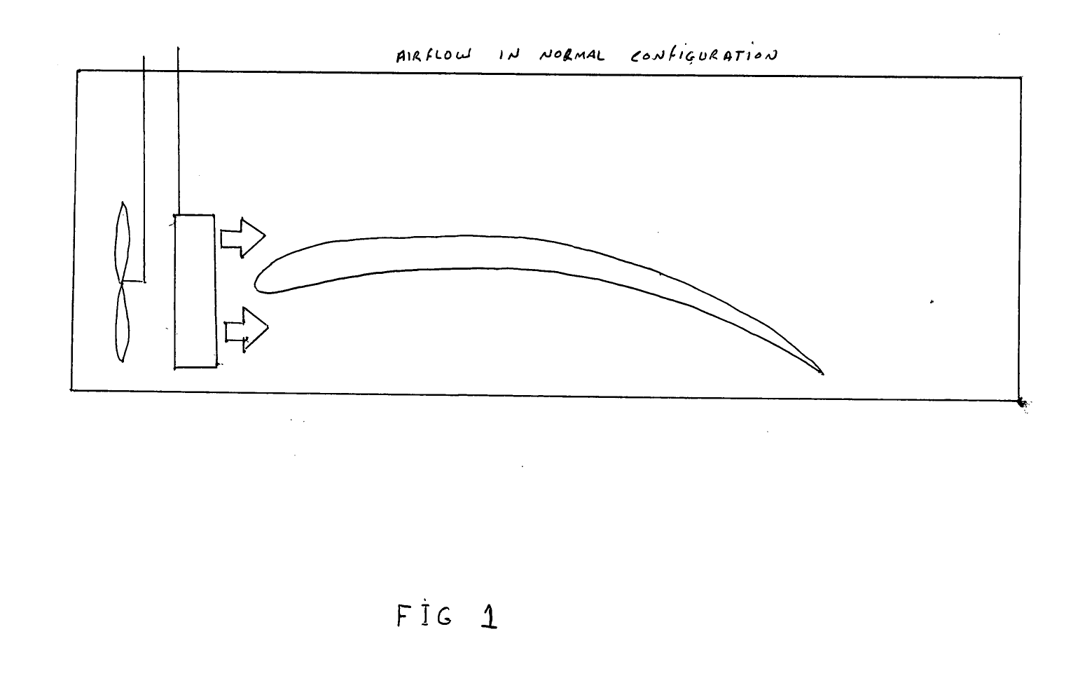

FIG. 2; Illustrates a perspective view of the embodiment of the engine mountings rotating to provide lift on the forward part of the vehicle. This stage is where the craft balances at an angular position to allow the craft to lift off.

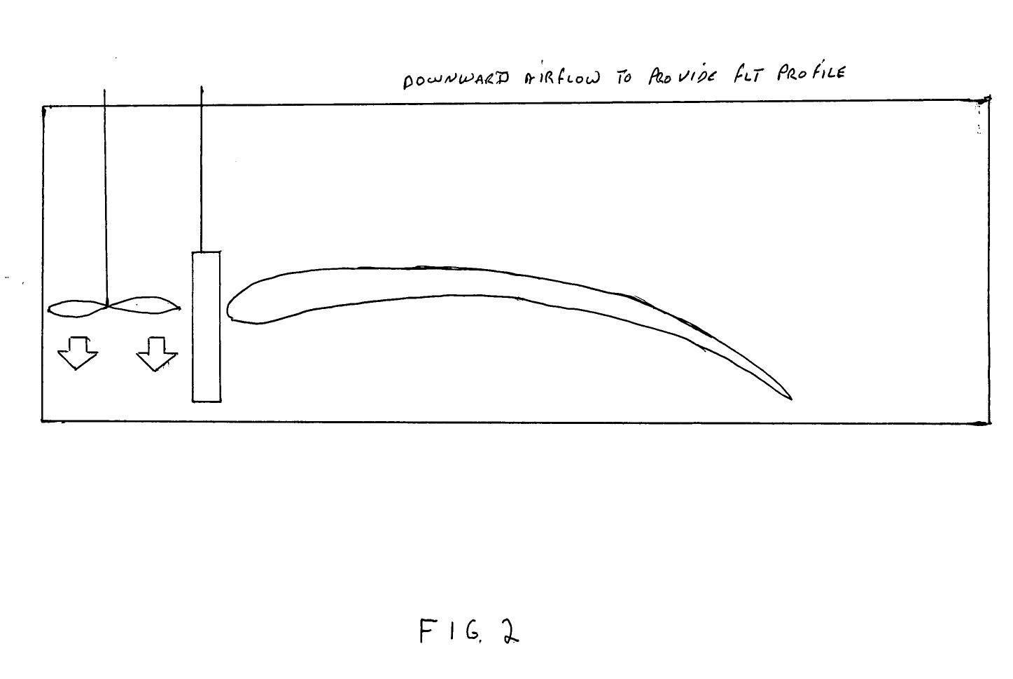

FIG. 3; Illustrates a perspective of how pressure builds up on the wing for flight.

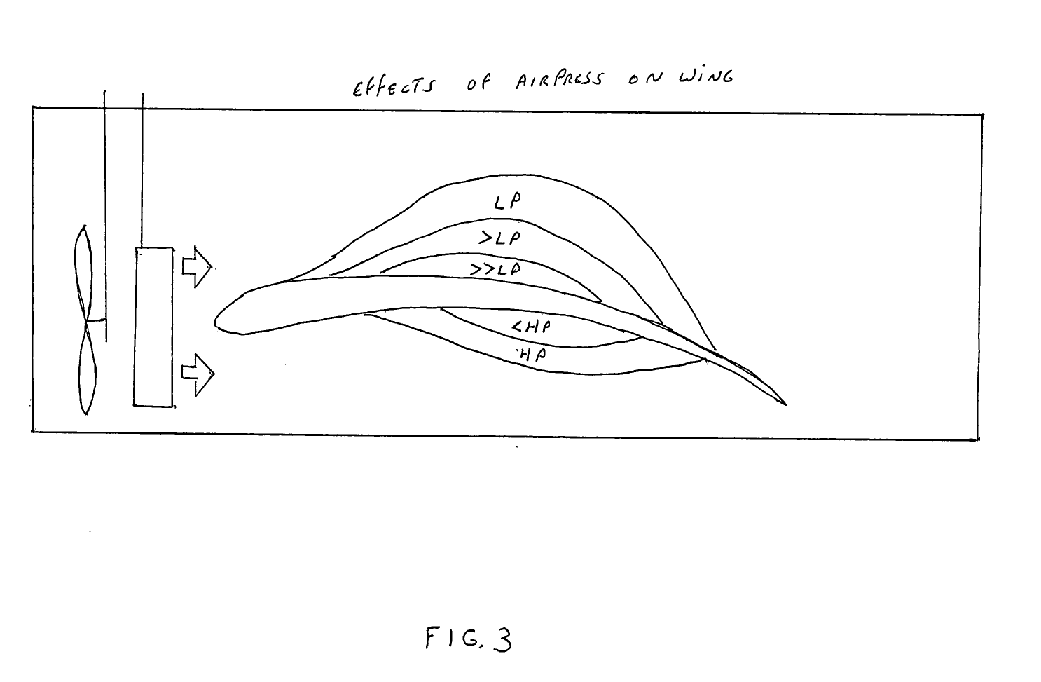

FIG. 4; Illustrates a perspective of the airflow effecting the wing in the ground effect.

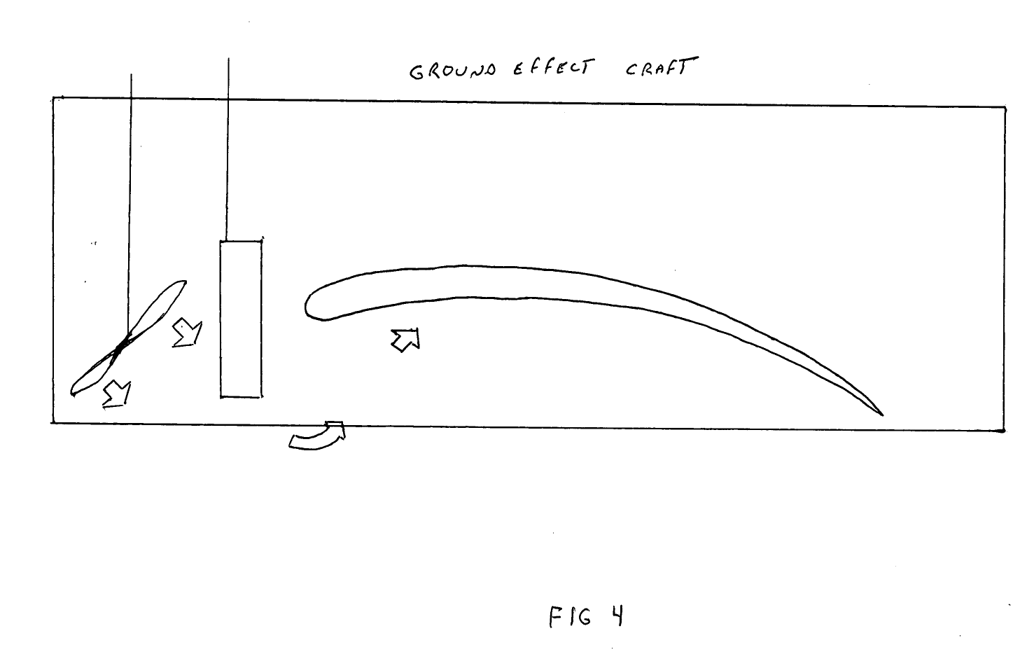

The invention claimed is:

1. It is hereby claimed that the craft described herein produces lift for flight by airflow over a wing. The airflow is contained under the craft by the containment body. Sufficient airflow is provided by a ducted fan, or propeller

2. The craft as defined in claim 1, comprising a tunnel wing design. The wing being mounted between two solid side support structures. The side support structures also contain the airflow over the wing making a tunnel like effect. The wing can be one piece or multiple sections. The wing can be either a single airfoil design or be equipped with leading and/or trailing edge devises. The lift and control devices are contained with in the body of the craft. The shape is boxy in nature and can be fitted for multiple uses.

3. The craft as defined in claim 1, comprising a propeller, or ducted fan provides airflow over the wing to provide the lift for flight. The propeller/ducted fan is mounted on a rotate able axis to provide different degrees of downward airflow to raise the nose of the craft to a balance angle sufficient for flight.

4. The ducted fans/propellers are mounted sufficiently in front of the wing structure and centered vertically to split the airflow over the wing.

5. Yaw control is accomplished by multiple rudders placed aft of the air source and fwd of the wing. In a turn airflow is effected over the wing producing more lift on the outside edge of the wing in a turn achieving a bank angle.

6. The wing mentioned in claim 2, is a low aspect ratio wing with a width equal to or less than its aerodynamic cord. The whole wing structure is fitted within the confines of the body structure.

7. The craft mentioned in claim 1, is capable of flight at altitude or in the ground effect. The principle's are the same. The ground effect craft employ's design changes that make it physically impossible to maintain flight above the ground effect.

8. The crafts mentioned in claims 1 thru 7 are virtually the same but with minor differences whereas the engines mounted on the ground effect craft are fixed to an angle to achieve lift and thrust which raises the craft but insufficient airflow over the top of the wing for full flight.

9. The craft mentioned in claims 7 and claim 8 have different variations of the wing height as compared to the body of the craft. The wing on the ground effect craft is mounted closer to the floor which does not leave room to generate the required lift for flight.

10. The craft mentioned in claim 1, can be built from a variety of light weight materials. The ground effect craft should be made from material that is fluid buoyant.

11. The craft mentioned in claim 1, can be build to any size, also can be fitted with any body ie., automotive body, boat hull, or any other vehicle.
